(19) United States
(12) Patent Application Publication
(10) Pub. No.: US 2024/0020607 A1
(43) Pub. Date: Jan. 18, 2024

(54) SYSTEM AND METHOD FOR A MACHINE LEARNING OPERATIONS FRAMEWORK

(71) Applicants: Milan Digambar Dhore, Rocky Hill, CT (US); Rajesh Kamlakar Nerurkar, Charlotte, NC (US); Gaurav Chandrashekhar Patrikar, Concord, NC (US); Vasanth Madhavan Srinivasaraghavan, South Windsor, CT (US); James A Madison, Windsor, CT (US)

(72) Inventors: Milan Digambar Dhore, Rocky Hill, CT (US); Rajesh Kamlakar Nerurkar, Charlotte, NC (US); Gaurav Chandrashekhar Patrikar, Concord, NC (US); Vasanth Madhavan Srinivasaraghavan, South Windsor, CT (US); James A Madison, Windsor, CT (US)

(21) Appl. No.: 17/865,992

(22) Filed: Jul. 15, 2022

(51) Int. Cl. G06Q 10/06; G06N 20/00

(52) U.S. Cl. CPC G06Q 10/0633; G06N 20/00

(57) ABSTRACT

According to some embodiments, a ML framework for an enterprise may include an analytics data store containing electronic records that include record characteristics to be processed by a data as a service layer to create data virtualization. A ML feature pipeline may perform feature engineering based on the data virtualization to create a ML model, and a consumer layer may process operational system information utilizing a business rule engine. In addition, a real-time inference platform may expose an API endpoint associated with deployment of the ML model using the data received from the consumer layer. A CI/CD platform may then automatically provide feedback information to the ML feature pipeline regarding performance of the deployed ML model.

### TECHNICAL FIELD

The present application generally relates to computer systems and more particularly to computer systems that are adapted to accurately, efficiently, and/or automatically facilitate machine learning model development, deployment, and monitoring for an enterprise.

### BACKGROUND

An enterprise, such as a business, may want to facilitate Machine Learning (“ML”) operations associated with multiple organizations (e.g., departments or lines of business) within the enterprise. As used herein, the phrase ML may refer to a field of artificial intelligence devoted to understanding and building models or algorithms (e.g., predictive models) that learn by leveraging enterprise and other data to improve performance for a task. However, in some cases a lack of consistency across organizations can hamper the efficient operationalizing of ML models. For example, different goals, guidelines, and procedures between organizations can increase the overhead associated with real-time ML model deployment (e.g., for model hand-off, model testing, knowledge transfer, etc.). Moreover, a ML model feedback loop is typically manually performed and can become a barrier to model performance in operational environments. In addition, a lack of a common toolset and technologies across organizations can limit consistency and stability to the release cycle of bringing trusted ML models into production.

By way of example, an insurance enterprise may have very segregated departmental or organizational strategies and boundaries and much of the technology stack and business applications may execute on data centers (e.g., on-premises data centers). For ML model deployment, data science teams may manually hand-off ML models to a Chief Information Officer (“CIO”) or operational organizations. Due to organizational or departmental boundaries, it may be difficult to deploy any ML real-time model at scale. These kind of manual hand-offs, technical debt, and missing model deployment capabilities on a data science team may heavily impact business objectives and create a huge dependency on operational teams to support ML real-time models developed by the data science organization.

It would be desirable to provide improved systems and methods to accurately, efficiently, and/or automatically facilitate ML model development, deployment, and monitoring for an enterprise. Moreover, the information should be easy to access, understand, update, etc.

### SUMMARY OF THE INVENTION

According to some embodiments, systems, methods, apparatus, computer program code and means are provided to accurately, efficiently, and/or automatically facilitate ML model development, deployment, and monitoring for an enterprise in a way that provides fast and useful model creation and deployment and that allows for flexibility and effectiveness when monitoring the models.

According to some embodiments, a ML framework for an enterprise may include an analytics data store containing electronic records that include record characteristics to be processed by a data as a service layer to create data virtualization. A ML feature pipeline may perform feature engineering based on the data virtualization to create a ML model, and a consumer layer may process operational system information utilizing a business rule engine. In addition, a real-time inference platform may expose an API endpoint associated with deployment of the ML model using the data received from the consumer layer. A CI/CD platform may then automatically provide feedback information to the ML feature pipeline regarding performance of the deployed ML model.

Some embodiments comprise: means for processing, by a computer processor of a data as a service layer in a data analytics organization of the enterprise, record characteristics from an analytics data store containing electronic records associated with the enterprise, each electronic record including an electronic record identifier and the record characteristics, to create data virtualization; means for performing, by a ML feature pipeline in the data analytics organization, feature engineering based on the data virtualization to create a ML model; means for processing, by a consumer layer in an operational system organization of the enterprise and implemented via a microservice framework, operational system information utilizing a business rule engine; means for receiving, by a real-time inference platform in a data science organization of the enterprise, the ML model created by the ML feature pipeline; means for receiving, by the real-time inference platform, data collected and prepared by the consumer layer utilizing the business rule engine; means for exposing, by the real-time inference platform, an Application Programming Interface (“API”) endpoint associated with deployment of the ML model using the data received from the consumer layer; and means for automatically providing, by a Continuous Integration/Continuous Delivery (“CI/CD”) platform in the data science organization, feedback information to the ML feature pipeline regarding performance of the deployed ML model.

In some embodiments, a communication device associated with a Machine Learning (“ML”) framework for an enterprise platform exchanges information with remote devices in connection with an interactive graphical operator or administrator interface. The information may be exchanged, for example, via public and/or proprietary communication networks.

A technical effect of some embodiments of the invention is an improved and computerized way to accurately, efficiently, and/or automatically facilitate machine learning model development, deployment, and monitoring for an enterprise in a way that provides fast and useful model creation and deployment. With these and other advantages and features that will become hereinafter apparent, a more complete understanding of the nature of the invention can be obtained by referring to the following detailed description and to the drawings appended hereto.

### BRIEF DESCRIPTION OF THE DRAWINGS

FIG. 1 is a high-level block diagram of a ML operations system in accordance with some embodiments.

FIG. 2 illustrates a ML operations method according to some embodiments of the present invention.

FIG. 3 is an end-to-end ML operations lifecycle in accordance with some embodiments.

FIG. 4 illustrates ML operations stages according to some embodiments.

FIG. 5 is a more detailed ML operations process in accordance with some embodiments.

FIG. 6 is a ML operations capability and ownership diagram according to some embodiments.

FIG. 7 is a more detailed operational systems in accordance with some embodiments.

FIG. 8 is a more detailed data science system according to some embodiments.

FIG. 9 is a more detailed data analytics system in accordance with some embodiments.

FIG. 10 is a ML operations system display according to some embodiments.

FIG. 11 is a block diagram of an apparatus in accordance with some embodiments of the present invention.

FIG. 12 is a portion of a ML operations data store according to some embodiments.

FIG. 13 illustrates a tablet computer with a ML operations system display according to some embodiments.

### DETAILED DESCRIPTION

Before the various exemplary embodiments are described in further detail, it is to be understood that the present invention is not limited to the particular embodiments described. It is also to be understood that the terminology used herein is for the purpose of describing particular embodiments only and is not intended to limit the scope of the claims of the present invention.

In the drawings, like reference numerals refer to like features of the systems and methods of the present invention. Accordingly, although certain descriptions may refer only to certain figures and reference numerals, it should be understood that such descriptions might be equally applicable to like reference numerals in other figures.

The present invention provides significant technical improvements to facilitate data analytics associated with a ML operations system. The present invention is directed to more than merely a computer implementation of a routine or conventional activity previously known in the industry as it provides a specific advancement in the area of electronic record analysis by providing improvements in the operation of a computer system so that organizations can more easily and efficiently access information about enterprise ML operations integration tools (as well as other applications). The present invention provides improvement beyond a mere generic computer implementation as it involves the novel ordered combination of system elements and processes to provide improvements in the ease and speed at which such information may be performed shared. Some embodiments of the present invention are directed to a system adapted to automatically analyze electronic records, aggregate data from multiple sources, distribute status information via information channels, etc. Moreover, communication links and messages may be automatically established, aggregated, formatted, exchanged, etc. to improve network performance (e.g., by reducing an amount of network messaging bandwidth and/or storage required to support ML operations).

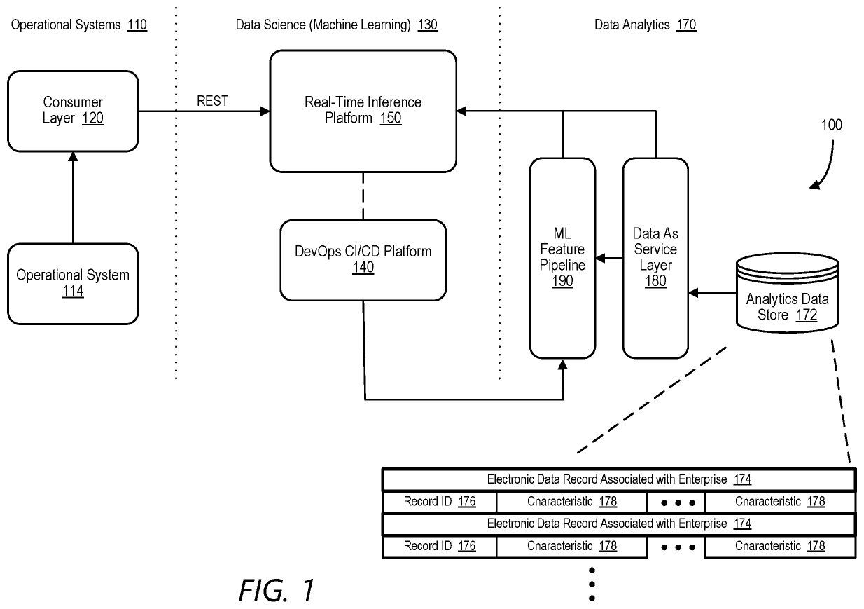

FIG. 1 is a high-level block diagram of a ML operations system 100 according to some embodiments of the present invention. In particular, the system 100 includes an operational systems 110 organization of an enterprise. As used herein, the phrase “operational systems” 110 may refer to an organization associated with data warehousing that processes the day-to-day transactions of an organization. The operational systems 110 may help ensure that day-to-day transactions are performed efficiently, and that the integrity of transactional data is preserved. The operational systems 110 may include a consumer layer 120 that receives information from an operational system 114. The consumer layer 120 may output a Representational State Transfer (“REST”) signal.

The system 100 also includes a data science 130 organization of the enterprise. As used herein, the phrase “data science” 130 may refer to an organization that uses scientific methods, processes, algorithms, and systems to extract knowledge and insights from noisy (structured and unstructured) data. The data science 130 organization may then apply that knowledge across a broad range of application domains (e.g., in connection with data mining, machine learning, big data, etc.). A real-time inference platform 150 in the data science 130 organization receives the REST signal from the consumer layer 120 and interfaces with a Development and Operations (“DevOps”) Continuous Integration/Continuous Delivery (“CI/CD”) platform 140. As used herein, the phrase “CI” may refer to the practice of merging developers' working copies to a shared enterprise system (e.g., several times a day) while the phrase “CD” may refer to the production of software in short cycles (e.g., such that the software can be reliably released at any time without doing so manually).

The system 100 further includes a data analytics 170 organization of the enterprise. As used herein, the phrase “data analytics” 170 may refer to an organization that applies analytics to business data to describe, predict, and improve business performance (e.g., in connection with descriptive analytics, diagnostic analytics, predictive analytics, prescriptive analytics, cognitive analytics, etc.). The data analytics 170 includes a ML feature pipeline 190 and a data as a service layer 180 that provide a ML model to the real-time inference platform 150. The ML feature pipeline 190 further receives information form the DevOps CI/CD platform 140 as feedback to improve ML models. The data analytics 170 further includes an analytics data store 172 that stores electronic records 174 associated with an enterprise (e.g., data warehouse information, third-party data, etc.) including record identifiers 176 and record characteristics 178.

The real-time inference platform 150 may, use the ML model that was created based on the record characteristics 178. The real-time inference platform 150 may also store information into other data stores and utilize a runtime environment to view, analyze, and/or update the ML models and electronic records 174. The real-time inference platform 150 may also exchange information with a cloud-based environment (e.g., via a firewall) executing the consumer layer 120. According to some embodiments, an interactive graphical user interface platform of the real-time inference platform 150 (and, in some cases, enterprise data and/or third-party data) may facilitate forecasts, decisions, predictions, and/or the display of alerts or communications via one or more remote administrator computers (e.g., to identify appropriate updates to rules and logic). Note that the real-time inference platform 150 and/or any of the other devices and methods described herein might be associated with a third party, such as a vendor that performs a service for an enterprise.

The real-time inference platform 150 and/or the other elements of the system 100 might be, for example, associated with a Personal Computer (“PC”), laptop computer, smartphone, an enterprise server, a server farm, and/or a database or similar storage devices. According to some embodiments, an “automated” real-time inference platform 150 (and/or other elements of the system 100) may facilitate automated ML operations. As used herein, the term “automated” may refer to, for example, actions that can be performed with little (or no) intervention by a human.

As used herein, devices, including those associated with the real-time inference platform 150 and any other device described herein, may exchange information via any communication network which may be one or more of a Local Area Network (“LAN”), a Metropolitan Area Network (“MAN”), a Wide Area Network (“WAN”), a proprietary network, a Public Switched Telephone Network (“PSTN”), a Wireless Application Protocol (“WAP”) network, a Bluetooth network, a wireless LAN network, and/or an Internet Protocol (“IP”) network such as the Internet, an intranet, or an extranet. Note that any devices described herein may communicate via one or more such communication networks.

The real-time inference platform 150 may store information into and/or retrieve information from various data stores. These data stores might be locally stored or reside remote from the real-time inference platform 150. As will be described further below, the data stores may be used by the real-time inference platform 150 in connection with an interactive user interface to access and update various electronic records. Although a single real-time inference platform 150 is shown in FIG. 1, any number of such devices may be included. Moreover, various devices described herein might be combined according to embodiments of the present invention. For example, in some embodiments, the real-time inference platform 150 and DevOps CI/SD platform might be co-located and/or may comprise a single apparatus.

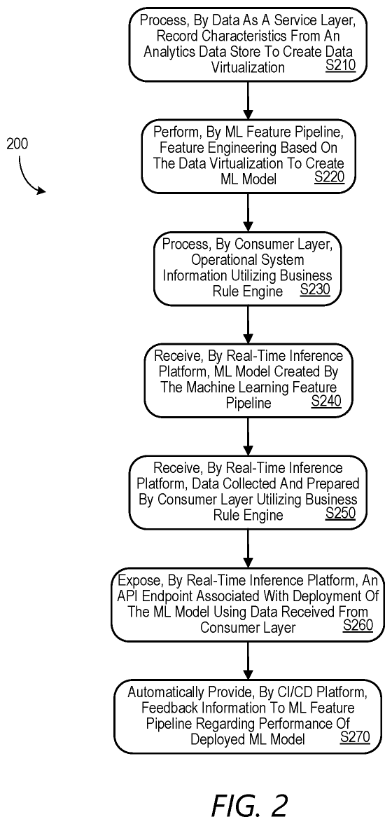

Note that the system 100 of FIG. 1 is provided only as an example, and embodiments may be associated with additional elements or components. FIG. 2 illustrates a method 200 that might be performed by some or all of the elements of the system 100 described with respect to FIG. 1, or any other system described herein, according to some embodiments of the present invention. The flow charts described herein do not imply a fixed order to the steps, and embodiments of the present invention may be practiced in any order that is practicable. Note that any of the methods described herein may be performed by hardware, software, or any combination of these approaches. For example, a computer-readable storage medium may store thereon instructions that when executed by a machine result in performance according to any of the embodiments described herein.

At S210, a computer processor of a data as a service layer (in a data analytics organization of an enterprise) may process record characteristics from an analytics data store to create data virtualization. The analytics data store may, for example, contain electronic records associated with the enterprise (each electronic record including an electronic record identifier and the record characteristics). At S220, a ML feature pipeline in the data analytics organization may perform feature engineering based on the data virtualization to create a ML model. At S230, a consumer layer in an operational system organization of the enterprise (e.g., implemented via a microservice framework) may process operational system information utilizing a business rule engine.

At S240, a real-time inference platform in a data science organization of the enterprise may receive the ML model created by the ML feature pipeline. At S250, the real-time inference platform may receive the data collected and prepared by the consumer layer utilizing the business rule engine. The data received by the real-time inference platform from the consumer layer may, according to some embodiments, comprise REST information processed via an API gateway, and/or an application load balancer in the data science organization.

At S260, the real-time inference platform may expose an Application Programming Interface (“API”) endpoint associated with deployment of the ML model using the data received from the consumer layer. At S270, a CI/CD platform in the data science organization may automatically provide feedback information to the ML feature pipeline regarding performance of the deployed ML model. The CI/CD platform may be associated with, according to some embodiments, a software development enterprise team and/or an information technology operations enterprise team.

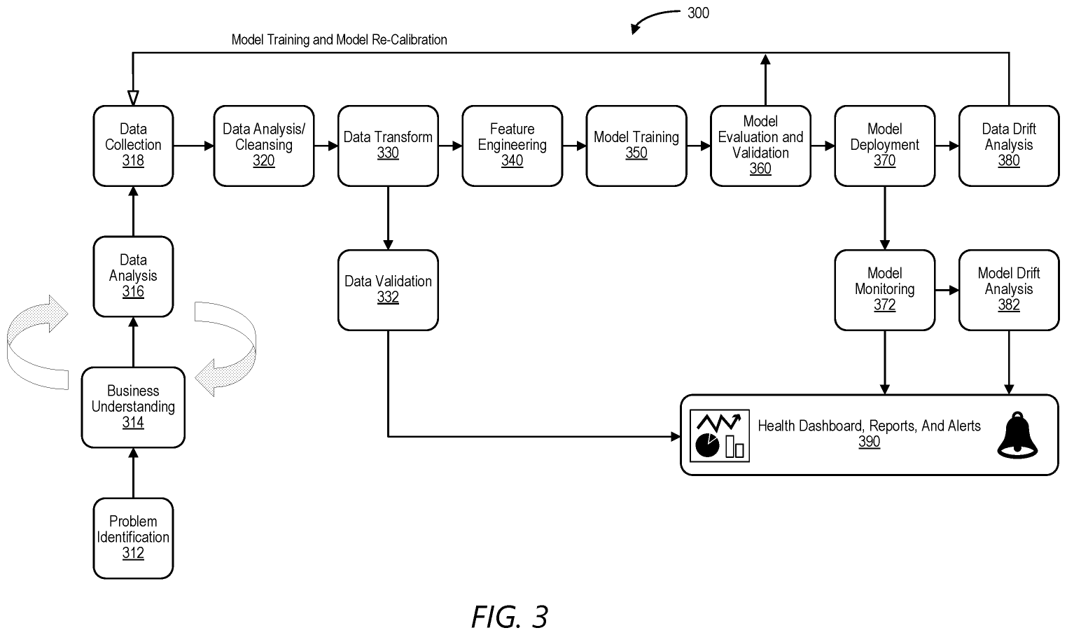

In this way, embodiments may provide a robust but simple architecture strategy, pattern, and capability matrix setting forth responsibilities to deploy real-time ML model and consume them in operational systems at scale. Hybrid architectures and designs may implement a ML lifecycle to enable real-time ML model deployment (and consumption of those models) at scale across the enterprise. For example, FIG. 3 is an end-to-end ML operations lifecycle 300 in accordance with some embodiments. After identifying the problem at 312, business understating 314 and data analysis 316 may work together interactively to determine appropriate data collection at 318. Once the appropriate data is collected, it may data analysis and cleansing may be performed at 320 and a transformation may be applied to the data at 330. Feature engineering may be performed at 340 using domain knowledge to extract features (e.g., characteristics, properties, attributes, etc.) from raw data to improve the quality of results from a ML process. Model training 350 may then be implemented, and model evaluation and validation 360 may be performed (and, if needed, the lifecycle 300 may continue with further data collection 318 for further model training or recalibration).

The model may then be deployed 370. After deployment, a data drift analysis 380 may be executed, and model monitoring 372 may be performed (e.g., for model drift analysis 382). Information from data validation 332, model monitoring 372, and model drift analysis 382 may be used, according to some embodiments, to support a health dashboard, reports, and alerts 390.

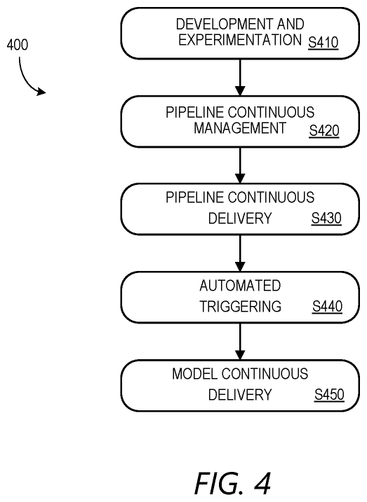

FIG. 4 illustrates ML operations stages 400 according to some embodiments. Initially, development and experimentation S410 may be performed for new ML algorithms or models (e.g., generating source code for pipelines for data extraction, validation, preparation, model training, model evaluation, model testing, etc.). Next, pipeline continuous management S420 may be performed to build source code and run tests (e.g., to generate pipeline components to be deployed, such as packages and executables). Pipeline continuous deliver S430 may then be performed to deploy pipelines to a target environment (with the new implementation of the ML model). Automated triggering S440 may then be performed so that the pipeline is automatically executed in production (the trained model that is stored in a model registry). Finally, model continuous deliver S450 may implement the model to serve predictions (e.g., by exposing the model as a REST API).

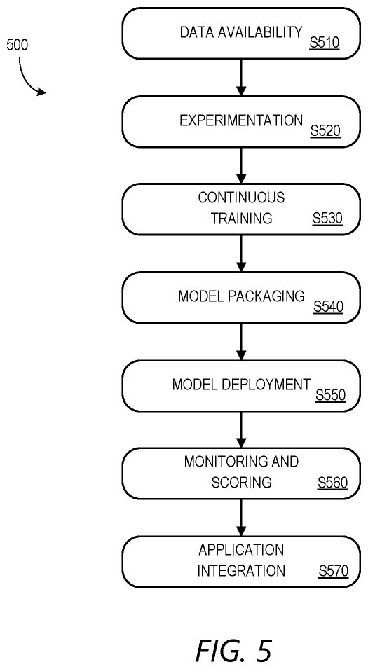

FIG. 5 is a more detailed ML operations process 500 in accordance with some embodiments. Data availability is determined at S510 (e.g., enterprise data, third-party data, etc.), and experimentation is performed at S520 to help configure ML model parameters. After continuous training at S530, the ML model may be packaged at S540 and deployed at S550. The system may then monitor and score the ML model at S560 to evaluate how it is performing for the enterprise. When the model is performing at a satisfactory level, application integration can be executed at S570 to complete the lifecycle.

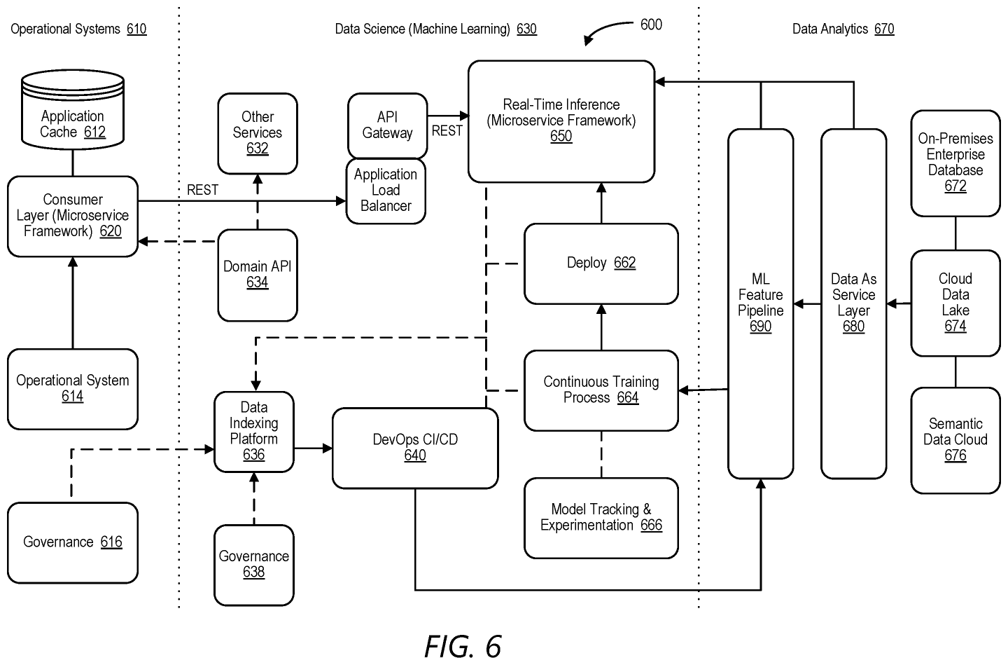

FIG. 6 is a ML operations capability and ownership diagram 600 according to some embodiments. As before, the system 600 includes an operational systems 610 organization, a data science 630 organization, and a data analytics 670 organization of an enterprise.

The operational systems 610 may include a consumer layer 620 (e.g., implemented via a microservice framework) that receives information from an operational system 614 and communicates with an application cache 612 (e.g., storing business applications of the enterprise). The consumer layer 620 may output a REST signal to data science 630. According to some embodiments, the operational systems 610 further includes governance information 616 (e.g., to ensure that high data quality exists, and data controls are implemented that support business objectives).

The data science 630 may include a real-time inference platform 650 (e.g., implemented via a microservice framework) that receives the REST signal from the consumer layer 620 via an API gateway and application load balancer. If required, a domain API 634 may access other services 632 in the data science 630 organization of the enterprise. A data indexing platform 636 receives governance data 616 from the operational systems 610, along with governance data 638 local to data science, and provides information to a DevOps CI/CD platform 640. The real-time inference platform 650 also interfaces with the DevOps CI/CD platform 640. A continuous training process 664 interacts with model tracking and experimentation 666 to deploy 662 a ML model.

The data analytics 670 includes a ML feature pipeline 690 and a data as a service layer 680 that provide a ML model to the real-time inference platform 650. The ML feature pipeline 690 further receives information form the DevOps CI/CD platform 640 as feedback to improve ML models. The data analytics 670 further includes an on-premises enterprise database 672, cloud lake data 674, and a semantic data cloud 676.

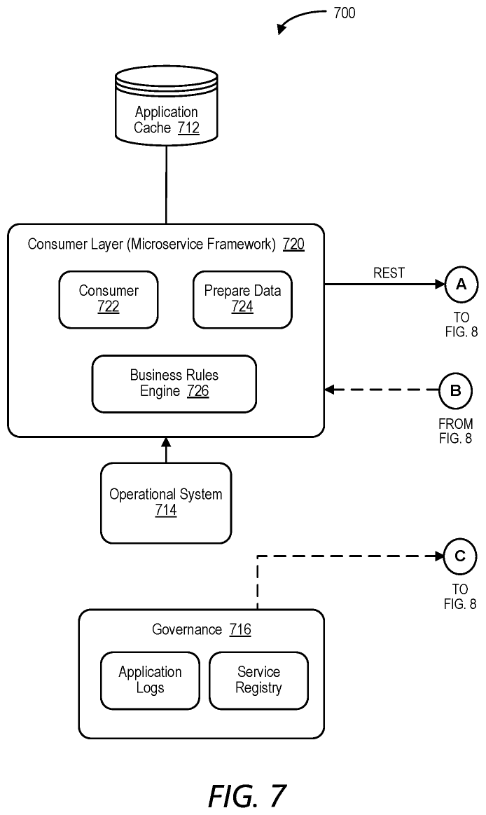

FIG. 7 is a more detailed operational systems 700 in accordance with some embodiments. The operational systems 700 may include a consumer layer 720 (e.g., implemented via a microservice framework) that receives information from an operational system 714 and communicates with an application cache 712 (e.g., storing business applications of the enterprise). The operational systems 714 (e.g., an on-premises system) may invoke a consumer microservice via a private API endpoint through an AMAZON® WEB SERVICES (“AWS”) direct connect gateway. From a model as a service perspective, this may provide a capability for operational or business applications to call ML model endpoints based on business requirements.

The consumer layer 720 may be associated with, for example, a consumer 722, data preparation 724, and a business rules engine 726. The consumer layer 720 may be implemented “one per use case” and may optionally collect and prepare data (and execute pre-processing rules) before invoking one or more data insight microservices (followed by invoking post processing rules). The consumer layer 720 may output a REST signal to data science. According to some embodiments, the operational systems 710 further includes a governance information 716. The governance information 716 may, for example, include application logs and/or a service registry.

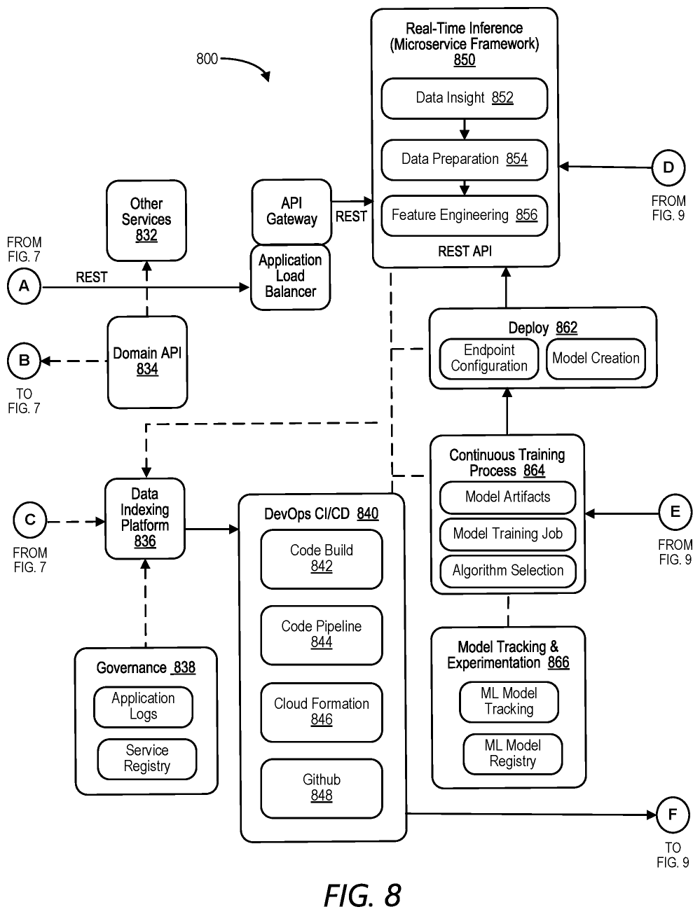

FIG. 8 is a more detailed data science system 800 according to some embodiments. The data science system 800 may include a real-time inference platform 850 (e.g., implemented via a microservice framework) that receives the REST signal from the consumer layer 720 via an API gateway and application load balancer. The real-time inference platform 850 may be associated with data insight 852, data preparation 854, feature engineering 856, etc. According to some embodiments, data insight 852 is implemented “one per model” and optionally collects and prepares additional data, calls feature engineering microservice and then a model launcher to load and execute the model. Data analytics teams may own feature engineering whereas data science teams own model launcher microservices. According to some embodiments, AWS® Fargate and Elastic Container Service (“ECS”) are used for microservice deployment. As a per model as a service strategy, data science may expose API endpoints for operational organizations. According to some embodiments, an AWS® fully managed Sagemaker deployment feature may expose model endpoints (with lambda integration). Model deployment may be owned by data science a single API may be provided for any patterns of real-time ML model inference.

If required, a domain API 834 may access other services 832 in the data science organization of the enterprise. For example, if a consumer microservice needs additional data, it may call other services 832 (which could be hosted in AWS, on-premises, or a vendor).

A data indexing platform 836 receives governance data 716 from the operational systems, along with governance data 838 local to data science, and provides information to a DevOps CI/CD platform 840. The local governance information 838 may, for example, include application logs and/or a service registry. According to some embodiments, application service logs may be pushed to a central governance platform (e.g., a data science Elasticsearch, Logstash, and Kibana (“ELK”) stack may subscribe to an AMAZON® Cloudwatch event to get application logs).

The real-time inference platform 850 also interfaces with the DevOps CI/CD platform 840. The DevOps CI/CD platform 840 may be associated with code build 842, a code pipeline 844, cloud formation 846, and software development hosting and version control such as GITHUB® 848. According to some embodiments, CI/CD pipelines may be utilized to automate most of component in architecture patterns.

A continuous training process 864 (e.g., associated with model artifacts, model training job, and algorithm selection) interacts with model tracking and experimentation 866 (e.g., associated with ML model tracking and a ML model registry) to deploy 862 a ML model. According to some embodiments, data science owns the ML model or algorithm training capability. Due to this capability and the continuous training process 864, model endpoints payload response can provide higher accuracy towards business or operational system requirements. The deployment 862 may be associated with an endpoint configuration and/or model creation. The model tracking and experimentation 866 may provide a capability to track and record all metrics related to the ML model experimentation at a central location (e.g., to help data scientists boost ML model performance).

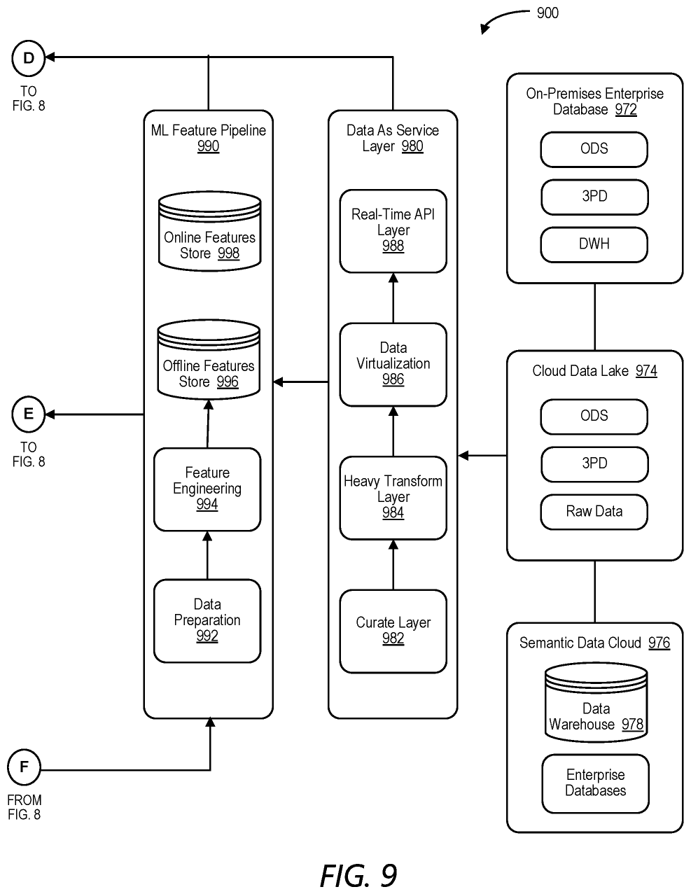

FIG. 9 is a more detailed data analytics system 900 in accordance with some embodiments. The data analytics includes a ML feature pipeline 990 that includes data preparation 992, feature engineering 994, an offline features store 996, and an online features store 998. Note that feature engineering is significant component of ML operations. The ML feature pipeline 990 approach makes ML model development, training, and deployment relatively easy to scale. Ultimately, the purpose of a pipeline is to increase the iteration cycle and scale how many models an enterprise can realistically keep in production (with the added confidence of coding the process).

The ML feature pipeline 990 receives information from a data as a service layer 980 that includes a batch layer (e.g., curate layer 982 and/or heavy transform layer 984), data virtualization 986, and a real-time API layer 988. As a Data as Service (“DaaS”) strategy, data analytics teams may expose API endpoints for data science organizations. This pipeline may also provide the data virtualization 986 for substantial data consumption needs (e.g., using an AWS® fully managed Sagemaker feature store or open-source Feast platform).

The ML feature pipeline 990 and data as a service layer 980 provide a ML model to the real-time inference platform 950. The ML feature pipeline 990 further receives information form the DevOps CI/CD platform 840 as feedback to improve ML models. The data analytics further includes an on-premises enterprise database 972 (e.g., associated with an Operational Data Store (“ODS”), third-party data, a data warehouse, etc.), cloud data lake 974 (e.g., associated with an ODS, third-party data, raw data, etc.), and a semantic data cloud 976 (e.g., associated with a data warehouse 978 and enterprise databases). According to some embodiments, a data science team may consume on-premises sources based on data needs (if the required dataset is not available). Moreover, raw data in the cloud data lake 974 may be consumed from an EDO data lake for model development and training. The cloud data lake 974 might be built, for example, using AWS® Simple Storage Service (“S3”) or a SNOWFLAKE data cloud platform (e.g., using a small sample set of data from these buckets for ML model development). According to some embodiments, semantic and conformed data in the cloud may be consumed from an EDO SNOWFLAKE platform (e.g., using data sampling for ML model development).

In some embodiments, the data analytics system 900 may be implemented such that the “shape” of data associated with model scoring is modularized and consistent so it can also be used with model training (e.g., JavaScript Object Notation (“JSON”) may follow the same model in both places). Moreover, embodiments of the data analytics system 900 may provide integration with an event-driven, serverless computing platform having a computing service that runs code in response to events and automatically manages the computing resources required by that code, such as AMAZON® Lambda. According to some embodiments, business logic is created one time and is then used by the data analytics system 900 in both the production of curation in the warehouse and the transformation of data in real-time. That is, a Lambda-like architecture may be provided without needing a dual code base (e.g., using a command line tool such as KAPPA® that facilitates deployment of Lambda functions to AWS Lambda). According to some embodiments, the curate layer 982 is associated with a streaming architecture from real-time to curation (e.g., using a command line tool such as KAPPA® that facilitates deployment of Lambda functions to AWS Lambda).

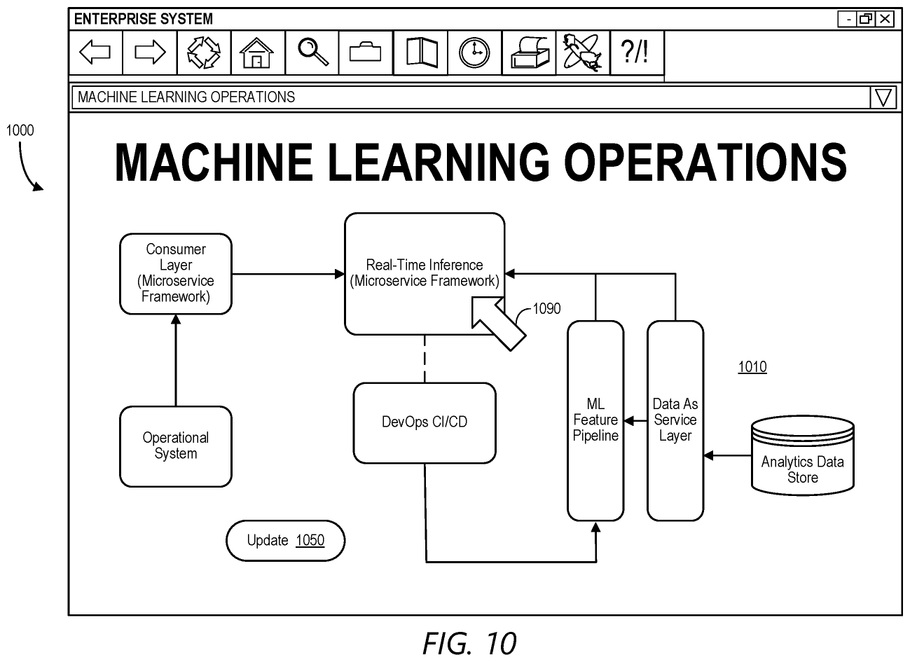

The configuration of a ML operations system may be presented on a Graphical User Interface (“GUI”). For example, FIG. 10 is a ML operations system display 1000 including graphical representations of elements of a ML operations system 1010 in accordance with any of the embodiments described herein. Moreover, selection of an element, such as a consumer layer or real-time inference platform (e.g., via touchscreen or computer mouse pointer 1090) may display configuration information about that element and/or let an operator or administrator adjust the configuration (e.g., to modify data mappings, add information about a ML model, etc.). The display 1000 may further let the operator or administrator select an “Update” icon 1050 to cause the system or platform to save changes, apply ML model reconfigurations, etc.

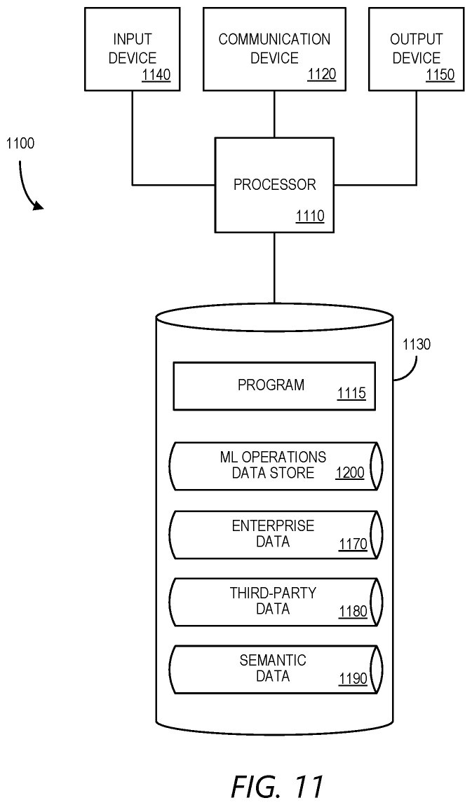

The embodiments described herein may be implemented using any number of different hardware configurations. For example, FIG. 11 illustrates an apparatus 1100 that may be, for example, associated with the systems and architectures 100, 600 described with respect to FIGS. 1 and 6, respectively. The apparatus 1100 comprises a processor 1110, such as one or more commercially available Central Processing Units (“CPUs”) in the form of one-chip microprocessors, coupled to a communication device 1120 configured to communicate via a communication network (not shown in FIG. 11). The communication device 1120 may be used to communicate, for example, with one or more remote cloud-based environments, administrator computers, and/or communication devices (e.g., PCs and smartphones). Note that communications exchanged via the communication device 1120 may utilize security features, such as those between a public internet operator or administrator and an internal network of an insurance company and/or an enterprise. The security features might be associated with, for example, web servers, firewalls, and/or PCI infrastructure. The apparatus 1100 further includes an input device 1140 (e.g., a mouse and/or keyboard to enter information about data sources, mappings, third-party details, etc.) and an output device 1150 (e.g., to output reports regarding ML operations, recommended changes, alerts, etc.).

The processor 1110 also communicates with a storage device 1130. The storage device 1130 may comprise any appropriate information storage device, including combinations of magnetic storage devices (e.g., a hard disk drive), optical storage devices, mobile telephones, and/or semiconductor memory devices. The storage device 1130 stores a program 1115 and/or ML operations engine or application for controlling the processor 1110. The processor 1110 performs instructions of the program 1115, and thereby operates in accordance with any of the embodiments described herein. For example, the processor 1110 may expose an API endpoint associated with deployment of a ML model using data received from a consumer layer. The processor 1110 may also automatically provide feedback information to a ML feature pipeline regarding performance of the deployed ML model.

The program 1115 may be stored in a compressed, uncompiled and/or encrypted format. The program 1115 may furthermore include other program elements, such as an operating system, a database management system, and/or device drivers used by the processor 1110 to interface with peripheral devices.

As used herein, information may be “received” by or “transmitted” to, for example: (i) the apparatus 1100 from another device; or (ii) a software application or module within the apparatus 1100 from another software application, module, or any other source.

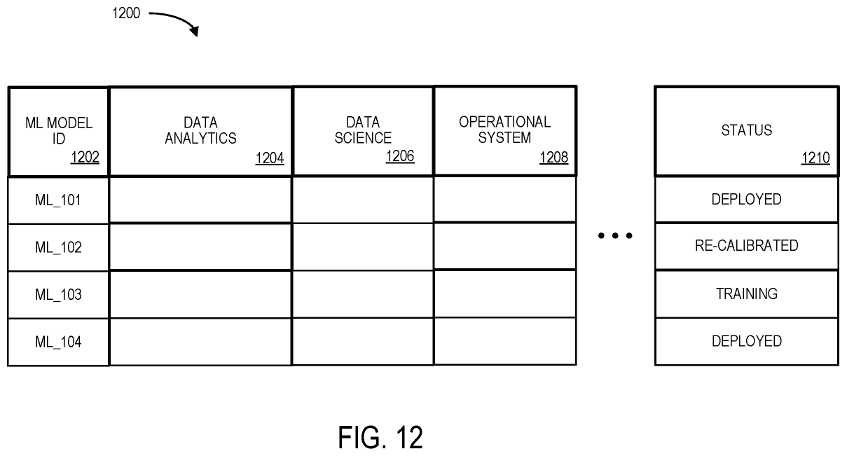

In some embodiments (such as shown in FIG. 11), the storage device 1130 further stores a ML operations data store 1200, enterprise data 1170 (e.g., associated with a business such as an insurance company), third-party data 1180, and semantic data 1190. An example of database that might be used in connection with the apparatus 1100 will now be described in detail with respect to FIG. 12. Note that the database described herein is only an example, and additional and/or different information may be stored therein. Moreover, various databases might be split or combined in accordance with any of the embodiments described herein. For example, the enterprise data 1170 and third-party data might be combined and/or linked to each other within the program 1115.

Referring to FIG. 12, a table is shown that represents the ML operations data store 1200 that may be stored at the apparatus 1100 according to some embodiments. The table may include, for example, entries associated with ML models. The table may also define fields 1202, 1204, 1206, 1208, 1210 for each of the entries. The fields 1202, 1204, 1206, 1208, 1210 may, according to some embodiments, specify: a ML model identifier 1202, data analytics 1204 information, data science 1206 information, operational system 1208 information, and a status 1210. The ML operations data store 1200 may be created and updated, for example, based on information electrically received from various data sources (e.g., including when ML models are added or deleted, new electronic characteristics are identified, model monitoring tools are updated, etc.) that may be associated with an insurer or other enterprise.

The ML model identifier 1202 may be, for example, alphanumeric codes that identifies a particular ML model that is being developed or has been deployed for an enterprise. The data analytics 1204 information, the data science 1206 information, and the operational system 1208 information may represent various organizations in the enterprise that are working together to support a ML model framework. The status 1210 might indication that a ML model is deployed, is being re-calibrated, is in training, etc.

Thus, embodiments may provide an automated and efficient way to help minimize inefficiencies across an application delivery lifecycle, letting teams be more successful. Moreover, an automated CI/CD pipeline may be provided for ML model deployment and a model endpoint may be exposed as service. Embodiments may employ a “Data Science as a Service” strategy such that there is no code hand-off between teams for real-time deployments. In addition, a fully integrated ML platform from development to deployment via ML operations practice and DevSecOps principles. Further, an automated model feedback loop may continuously improve model performance and standardized toolsets and technologies may be provided across enterprise organization to bring consistency and stability to the release cycle of trusted ML models into production.

The following illustrates various additional embodiments of the invention. These do not constitute a definition of all possible embodiments, and those skilled in the art will understand that the present invention is applicable to many other embodiments. Further, although the following embodiments are briefly described for clarity, those skilled in the art will understand how to make any changes, if necessary, to the above-described apparatus and methods to accommodate these and other embodiments and applications.

Although specific hardware and data configurations have been described herein, note that any number of other configurations may be provided in accordance with embodiments of the present invention (e.g., some of the information associated with the displays described herein might be implemented as a virtual or augmented reality display and/or the databases described herein may be combined or stored in external systems). Moreover, although embodiments have been described with respect to specific types of enterprises, embodiments may instead be associated with other types of enterprises in additional to and/or instead of those described herein (e.g., banks or other financial institutions). Similarly, although certain types of ML models and parameters were described in connection some embodiments herein, any other types of models and parameters might be used instead.

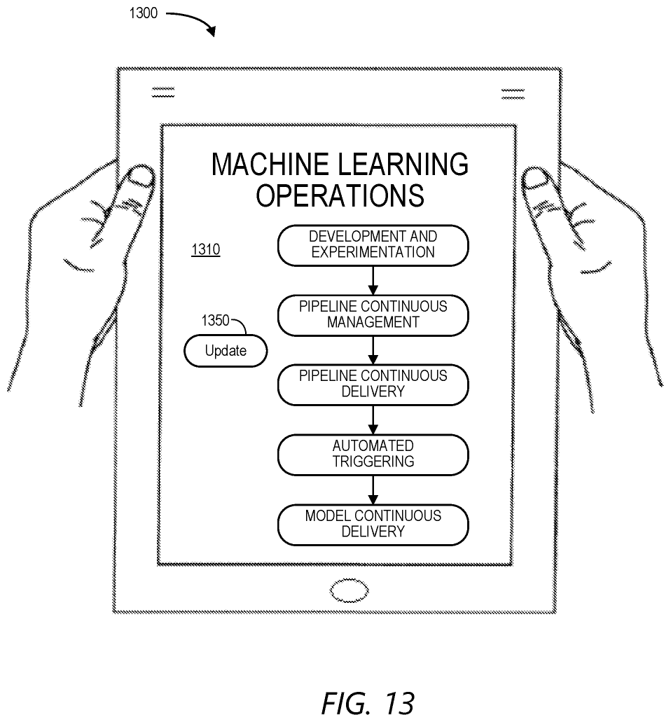

Note that the displays and devices illustrated herein are only provided as examples, and embodiments may be associated with any other types of operator or administrator interfaces. For example, FIG. 13 illustrates a handheld tablet computer 1300 with a ML operations system display 1310 according to some embodiments. The ML operations system display 1310 shows elements of an architecture that might include selectable data that can be modified by an operator or administrator of the tablet computer 1300 (e.g., via an “Update” icon 1350) to view updated ML operations system data associated with a Machine Learning (“ML”) framework for an enterprise (e.g., including, in some embodiments, available templates and mapping information).

The present invention has been described in terms of several embodiments solely for the purpose of illustration. Persons skilled in the art will recognize from this description that the invention is not limited to the embodiments described but may be practiced with modifications and alterations limited only by the spirit and scope of the appended claims.

What is claimed is:

1. A system associated with a Machine Learning (“ML”) framework for an enterprise, comprising:
(a) an analytics data store, in a data analytics organization of the enterprise, containing electronic records associated with the enterprise, each electronic record including an electronic record identifier and record characteristics to be processed by a data as a service layer to create data virtualization;
(b) a ML feature pipeline, in the data analytics organization, to perform feature engineering based on the data virtualization to create a ML model;
(c) a consumer layer, in an operational system organization of the enterprise and implemented via a microservice framework, to process operational system information utilizing a business rule engine;
(d) a real-time inference platform, in a data science organization of the enterprise, including:
a computer processor, and
a computer memory, coupled to the computer processor, storing instructions that, when executed by the computer processor cause the real-time inference platform to:
(i) receive the ML model created by the ML feature pipeline,
(ii) receive data collected and prepared by the consumer layer utilizing the business rule engine, and
(iii) expose an Application Programming Interface (“API”) endpoint associated with deployment of the ML model using the data received from the consumer layer; and
(e) a Continuous Integration/Continuous Delivery (“CI/CD”) platform, in the data science organization, to automatically provide feedback information to the ML feature pipeline regarding performance of the deployed ML model.

2. The system of claim 1, wherein the CI/CD platform is associated with at least one of: (i) a software development enterprise team, and (ii) an information technology operations enterprise team.

3. The system of claim 1, wherein the data received by the real-time inference platform from the consumer layer comprises Representational State Transfer (“REST”) information processed via at least one of: (i) an API gateway, and (ii) an application load balancer in the data science organization.

4. The system of claim 1, wherein a continuous training process platform in the data science organization performs ML algorithm selection, ML model training, and ML model artifact detection.

5. The system of claim 1, wherein a data indexing platform in the data science organization performs ML model monitoring and evaluation based on governance information and data from the real-time inference platform and transmits evaluation results to the CI/CD platform.

6. The system of claim 5, wherein the governance information is associated with at least one of: (i) application logs, and (ii) a service registry.

7. The system of claim 1, wherein the ML feature pipeline includes an online features store and an offline features store.

8. The system of claim 1, wherein the analytics data store is associated with at least one of: (i) an on-premises enterprise database, (ii) an operational datastore, (iii) a data warehouse, (iv) third-party data, (v) a cloud data lake, and (vi) semantic data.

9. The system of claim 1, wherein the data as a service layer is associated with at least one of: (i) a batch layer, (ii) a curate layer, (iii) a heavy transform layer, and (iv) a real-time API layer.

10. A computerized method associated with a Machine Learning (“ML”) framework for an enterprise, comprising:
processing, by a computer processor of a data as a service layer in a data analytics organization of the enterprise, record characteristics from an analytics data store containing electronic records associated with the enterprise, each electronic record including an electronic record identifier and the record characteristics, to create data virtualization;
performing, by a ML feature pipeline in the data analytics organization, feature engineering based on the data virtualization to create a ML model;
processing, by a consumer layer in an operational system organization of the enterprise and implemented via a microservice framework, operational system information utilizing a business rule engine;
receiving, by a real-time inference platform in a data science organization of the enterprise, the ML model created by the ML feature pipeline;
receiving, by the real-time inference platform, data collected and prepared by the consumer layer utilizing the business rule engine;
exposing, by the real-time inference platform, an Application Programming Interface (“API”) endpoint associated with deployment of the ML model using the data received from the consumer layer; and
automatically providing, by a Continuous Integration/Continuous Delivery (“CI/CD”) platform in the data science organization, feedback information to the ML feature pipeline regarding performance of the deployed ML model.

11. The method of claim 10, wherein the CI/CD platform is associated with at least one of: (i) a software development enterprise team, and (ii) an information technology operations enterprise team.

12. The method of claim 10, wherein the data received by the real-time inference platform from the consumer layer comprises Representational State Transfer (“REST”) information processed via at least one of: (i) an API gateway, and (ii) an application load balancer in the data science organization.

13. The method of claim 10, wherein a continuous training process platform in the data science organization performs ML algorithm selection, ML model training, and ML model artifact detection.

14. The method of claim 10, wherein a data indexing platform in the data science organization performs ML model monitoring and evaluation based on governance information and data from the real-time inference platform and transmits evaluation results to the CI/CD platform.

15. The method of claim 14, wherein the governance information is associated with at least one of: (i) application logs, and (ii) a service registry.

16. A non-transitory, computer-readable medium storing instructions, that, when executed by a processor, cause the processor to perform a ML operations method associated with a Machine Learning (“ML”) framework for an enterprise, the method comprising:
processing, by a computer processor of a data as a service layer in a data analytics organization of the enterprise, record characteristics from an analytics data store containing electronic records associated with the enterprise, each electronic record including an electronic record identifier and the record characteristics, to create data virtualization;
performing, by a ML feature pipeline in the data analytics organization, feature engineering based on the data virtualization to create a ML model;
processing, by a consumer layer in an operational system organization of the enterprise and implemented via a microservice framework, operational system information utilizing a business rule engine;
receiving, by a real-time inference platform in a data science organization of the enterprise, the ML model created by the ML feature pipeline;
receiving, by the real-time inference platform, data collected and prepared by the consumer layer utilizing the business rule engine;
exposing, by the real-time inference platform, an Application Programming Interface (“API”) endpoint associated with deployment of the ML model using the data received from the consumer layer; and
automatically providing, by a Continuous Integration/Continuous Delivery (“CI/CD”) platform in the data science organization, feedback information to the ML feature pipeline regarding performance of the deployed ML model.

17. The medium of claim 16, wherein the CI/CD platform is associated with at least one of: (i) a software development enterprise team, and (ii) an information technology operations enterprise team.

18. The medium of claim 16, wherein the ML feature pipeline includes an online features store and an offline features store.

19. The medium of claim 16, wherein the analytics data store is associated with at least one of: (i) an on-premises enterprise database, (ii) an operational datastore, (iii) a data warehouse, (iv) third-party data, (v) a cloud data lake, and (vi) semantic data.

20. The medium of claim 16, wherein the data as a service layer is associated with at least one of: (i) a batch layer, (ii) a curate layer, (iii) a heavy transform layer, and (iv) a real-time API layer.
